(19) United States
(12) Patent Application Publication
(10) Pub. No.: US 2026/0205723 A1
(43) Pub. Date: Jul. 16, 2026

(54) SYSTEM FOR LINK ALLOCATION IN A CIRCUIT SWITCHED NETWORK ENVIRONMENT

(71) Applicant: MELLANOX TECHNOLOGIES, LTD., Yokneam (IL)

(72) Inventors: Nikolaos TERZENIDIS, Kilkis (GR); Ioannis (Giannis) PATRONAS, Piraeus (GR); Dimitrios SYRIVELIS, Volos (GR); Paraskevas BAKOPOULOS, Ilion (GR); Eitan ZAHAVI, Zichron Yaakov (IL); Zsolt-Alon WERTHEIMER, Kiryat Ata (IL); Louis Bennie CAPPS, JR., Georgetown, TX (US); Prethvi Ramesh KASHINKUNTI, Chicago, IL (US); Julie Irene Marcelle BERNAUER, Palo Alto, CA (US); Elad MENTOVICH, Tel Aviv (IL)

(73) Assignee: MELLANOX TECHNOLOGIES, LTD., Yokneam (IL)

(21) Appl. No.: 19/020,202

(22) Filed: Jan. 14, 2025

(30) Foreign Application Priority Data
Jan. 13, 2025 (GR) 20250100022

(51) Int. Cl. H04Q 11/00

(52) U.S. Cl. CPC H04Q 11/0062; H04Q 11/0005; H04Q 2011/0064; H04Q 2011/0086

(57) ABSTRACT

Systems, computer program products, and methods are described for link allocation in circuit switched network environment. An example system may include a plurality of electrical switches, a plurality of optical switches, and a link allocation circuitry. The link allocation circuitry may be configured to receive link allocation requests specifying a plurality of links to be allocated between pairs of electrical switches via corresponding optical switches. The link allocation circuitry may determine the maximum number of links available for allocation for each electrical switch pair and, if the requested number of links is less than or equal to the maximum available, allocates the links according to a predefined allocation policy, such as a round-robin allocation policy. If the initial allocation policy fails to meet the allocation requirements, the link allocation circuitry dynamically selects alternative policies to ensure efficient link allocation and maintain network reliability.

### CROSS-REFERENCE TO RELATED APPLICATION

This application claims the benefit of Greek patent application No. 20250100022, Jan. 13, 2025, the contents of which is hereby incorporated by reference in its entirety.

### TECHNOLOGICAL FIELD

Example embodiments of the present disclosure relate to the field of network communication systems, specifically focusing on the allocation and management of uplink connections within a network environment.

### BACKGROUND

In modern network environments, efficient allocation of resources across various switches (e.g., electrical switches) allows for maintaining optimal system performance. However, the integration and coordination of these switches often present challenges in terms of uplink allocation and management. Conventional methods of link allocation often fail to optimize the allocation of uplinks among available uplink bundles, leading to suboptimal system utilization and potential bottlenecks. As such, there is a need for a policy that can effectively assign and manage uplink connections for seamless execution of network tasks.

Applicant has identified a number of deficiencies and problems associated with allocation and management of uplink connections within a network environment. Many of these identified problems have been solved by developing solutions that are included in embodiments of the present disclosure, many examples of which are described in detail herein.

### BRIEF SUMMARY

Systems, methods, and computer program products are therefore provided for the optimization of system resources to improve the efficiency and reliability of network tasks.

In one aspect, a method for link allocation is presented. The method comprising: receiving a link allocation request, wherein the link allocation request comprises a plurality of links to be allocated between each electrical switch-pair via corresponding optical switches; determining, for each electrical switch in the electrical switch-pair, a maximum number of links available for allocation between the electrical switch-pair; and in an instance in which the plurality of links to be allocated is less than or equal to the maximum number of links available for allocation, allocating the plurality of links between each electrical switch-pair among available uplink bundles based on a first allocation policy, wherein the first allocation policy comprises a round-robin allocation policy.

In some embodiments, the first allocation policy comprises at least one of a sequential, least-loaded, most-loaded, or preferred batch allocation policy.

In some embodiments, determining the maximum number of links that can be established between each electrical switch-pair is based on an uplink bundle associated with each electrical switch in the electrical switch-pair.

In some embodiments, determining the maximum number of links for allocation further comprises: determining a first number of available links associated with a first electrical switch in the electrical switch-pair; determining a second number of available links associated with a second electrical switch in the electrical switch-pair; and determining a minimum of the first number of available links and the second number of available links, wherein the first number of available links and the second number of available links are associated with the uplink bundle.

In some embodiments, the method further comprises determining that the link allocation request is successful in an instance in which the plurality of links is allocated between each electrical switch-pair.

In some embodiments, the method further comprises determining that the link allocation request between a first electrical switch-pair is successful; and initiating the allocation in additional electrical switch-pairs.

In some embodiments, the method further comprises executing a task in response to determining that the link allocation request is successful.

In some embodiments, the method further comprises allocating the plurality of links between each electrical switch-pair concurrently.

In some embodiments, the method further comprises in an instance in which the link allocation request is unsuccessful using the first allocation policy, sequentially attempting additional allocation policies until the plurality of links is successfully allocated between each electrical switch-pair.

In some embodiments, the additional allocation policies comprise at least one of a round-robin among the uplink bundles, a sequential, least-loaded, most-loaded, or preferred batch allocation policy.

In some embodiments, the method further comprises in an instance in which the additional allocation policies were unsuccessful, transmitting an alert to a user indicating that additional allocation policies were unsuccessful.

In some embodiments, wherein the link allocation request is associated with a communication pattern.

In another aspect, a system for link allocation is presented. The system comprising: a plurality of electrical switches; a plurality of optical switches operatively coupled to the plurality of electrical switches; link allocation circuitry operatively coupled to the plurality of electrical switches and the plurality of optical switches, and configured to: receive a link allocation request, wherein the link allocation request comprises a plurality of links to be allocated between each electrical switch-pair via corresponding optical switches; determine, for each electrical switch in the electrical switch-pair, a maximum number of links available for allocation between the electrical switch-pair; and in an instance in which the plurality of links to be allocated is less than or equal to the maximum number of links available for allocation, allocate the plurality of links between each electrical switch-pair among available uplink bundles based on a first allocation policy, wherein the first allocation policy comprises a round-robin allocation policy.

In yet another aspect, a computer program product for link allocation is presented. The computer program product comprising a non-transitory computer-readable medium comprising code that, when executed by a processor, causes the processor to: receive a link allocation request, wherein the link allocation request comprises a plurality of links to be allocated between each electrical switch-pair via corresponding optical switches; determine, for each electrical switch in the electrical switch-pair, a maximum number of links available for allocation between the electrical switch-pair; and in an instance in which the plurality of links to be allocated is less than the maximum number of links available for allocation, allocate the plurality of links between each electrical switch-pair among available uplink bundles based on a first allocation policy, wherein the first allocation policy comprises a round-robin allocation policy.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a schematic diagram of an example datacenter network architecture, in accordance with an embodiment of the disclosure;

FIG. 2 illustrates a schematic block diagram of example circuitry, some or all of which may be included in the system, in accordance with embodiments described herein;

FIG. 3 illustrates an example method for link allocation, in accordance with an embodiment of the disclosure; and

FIGS. 4A-4C illustrate link allocation within an example network segment of the datacenter network topology, in accordance with an embodiment of the disclosure.

### DETAILED DESCRIPTION

### Overview

In network environments involving both electrical and optical switches, effective management of uplink connections is an important consideration to maintain network performance and reliability. Electrical switches are responsible for directing data traffic within the network, while optical switches handle high-bandwidth data transmission across different network segments. The integration of these two types of switches requires a coordinated approach to uplink allocation, where connections between electrical switches and optical switches must be effectively managed to optimize data flow. Conventional methods of uplink allocation often lead to suboptimal use of available uplink connections, resulting in network inefficiencies and potential data bottlenecks. This creates challenges in achieving seamless and efficient network operation, particularly as network demands and the number of devices increase. As such, there is a need for an improved approach to uplink allocation that addresses these inefficiencies and supports scalable, reliable network management.

Embodiments of the present disclosure introduce an uplink allocation policy configured to optimize the utilization of available uplink connections between electrical switches (e.g., electrical switches) and optical switches within a network environment. The proposed allocation policy determines the necessary uplinks between pairs of electrical switches and distributes them among available uplink bundles and optical switches to execute specific tasks efficiently. First, for each pair of electrical switches, an example system determines the minimum number of required uplink connections for successful resource allocation. Subsequently, the example system calculates the maximum number of uplinks that can be established for each uplink bundle associated with the switch pair, considering the available free links on both the electrical switches and their corresponding uplink bundles.

Once the maximum number of uplinks is determined, the example system distributes these uplinks among the available uplink bundles according to a predefined allocation policy, which may include strategies such as sequential, round-robin, least-loaded, most-loaded, or preferred batch. If the required number of uplinks is successfully assigned for all electrical switch pairs, the allocation is considered successful. In scenarios where the required number of uplinks is not achieved for some switch pairs, the allocation is deemed a failure, prompting the use of an alternative allocation policy. Should all available policies fail, a resource manager may either implement an alternative resource allocation policy or wait for additional resources to become available.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

Furthermore, as would be evident to one of ordinary skill in the art in light of the present disclosure, the terms “substantially” and “approximately” indicate that the referenced element or associated description is accurate to within applicable engineering tolerances.

### Example Datacenter Architecture

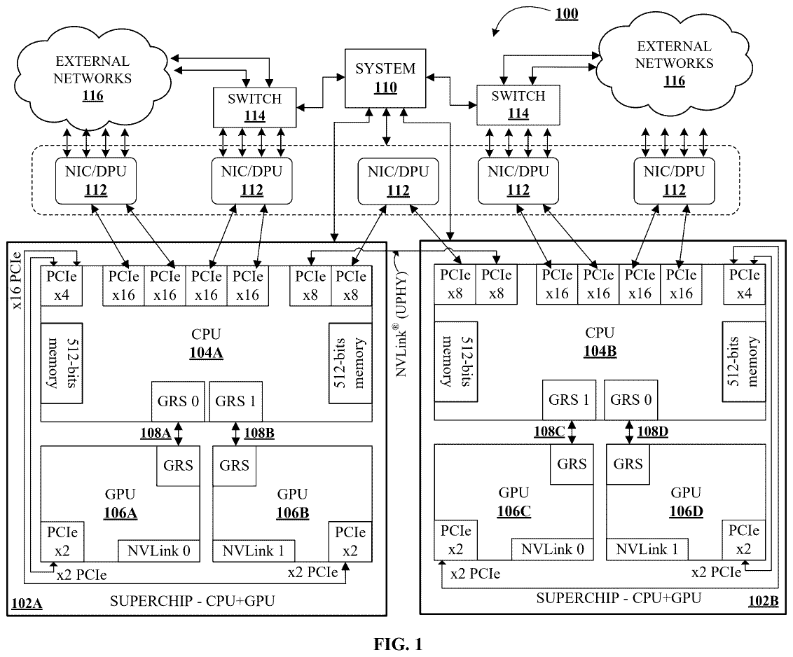

FIG. 1 illustrates a schematic diagram of an example datacenter network architecture 100, in accordance with an embodiment of the disclosure. The datacenter network architecture 100 may include high-performance computing (HPC) clusters 102A, 102B, network interface controller/data processing units (NIC/DPUs) 108, switches 114, external networks 116, and system 110. The HPC clusters 102A, 102B may house computing resources. The NIC/DPUs 112 may act as intermediate processing and management units that facilitate data transmission between HPC clusters 102A, 102B and datacenter switches 114. The datacenter switches 114 may manage and route data between the HPC clusters 102A, 102B and the external networks 116. The external networks 116 may connect the datacenter network architecture 100 to external devices, services, or other datacenters, enabling communication beyond the datacenter. The system 110 may serve as a centralized management and control system within datacenter network architecture 100, overseeing resource allocation, link management, and network optimization, according to various embodiments described herein.

HPC clusters (e.g., HPC clusters 102A, 102B) may house various computing resources designed to support computationally demanding tasks. These HPC clusters may include central processing units (CPUs), such as NVIDIA Grace™ CPUs, and graphics processing units (GPUs), such as NVIDIA® H100 Tensor Core GPUs, memory modules, and interconnects to facilitate data exchange and processing. In example embodiments, each HPC cluster may be configured to handle specific types of workloads, such as general-purpose computing, data processing, specialized tasks like artificial intelligence (AI) and machine learning (ML) applications, and/or the like. For example, NVIDIA® Tensor Core GPUs may be used to accelerate AI and ML workloads by performing parallel processing of large datasets. The configuration of the HPC clusters may be scalable, allowing for additional compute nodes, such as those with GPUs and CPUs, to be added or removed as needed based on computing requirements.

In specific embodiments, the CPU and/or the GPUs, or portions or components thereof, may be embodied as or include a chip or chipset. In other words, the CPU and/or the GPUs may include physical packages (e.g., chips) including materials, components, and/or wires on a structural assembly (e.g., a baseboard). The structural assembly may provide physical strength, conservation of size, and/or limitation of electrical interaction for component circuitry included thereon. The CPU and/or the GPUs, may therefore, in some cases, be configured to implement an embodiment of the disclosure on a single chip or as a single “system on a chip (SoC).” As such, in some cases, a chip or chipset may constitute means for performing one or more operations for providing the functionalities described herein. In this configuration, the CPU may be coupled to a GPU via die-to-die (D2D) interconnects, chip-to-chip (C2C) interconnects, such as a Ground-Referenced Signaling (GRS) interconnect, and/or the like, allowing for low-latency communication and high bandwidth between the CPU and GPU. Additionally, the CPU can connect to multiple GPUs using both D2D/C2C interconnects and high-speed interconnects, such as PCIe interconnects, such as PCIe Gen 5×16 lanes. Within each HPC cluster, the GPUs may also be operatively coupled to one another to facilitate direct GPU-to-GPU communication using high-speed interconnect technologies such as NVLink® or other interconnects specifically designed for direct GPU communication. NVLink® may provide a high-bandwidth, low-latency communication channel between GPUs, supporting data synchronization and sharing for tasks that require significant inter-GPU communication, such as matrix computations, simulations, or AI model training.

In the embodiment shown in FIG. 1, CPU 104A is operatively coupled to GPUs 106A and 106B via GRS-compatible interconnects, 108A and 108B, and CPU 104B is operatively coupled to GPUs 104C and 106D via GRS-compatible interconnects, 108C and 108D. Each CPU may include GRS-compatible ports, such as GRS 0 and GRS 1, which are configured to interface with corresponding GRS ports on the GPUs. For example, CPU 104A may utilize its GRS 0 port to connect to GPU 106A and its GRS 1 port to connect to GPU 106B, while CPU 104B may use its GRS 0 and GRS 1 ports to connect to GPUs 104C and 106D, respectively. The GRS-compatible interconnects may provide pathways for data exchange, workload distribution, and processing synchronization between the CPUs and GPUs, supporting high-bandwidth, low-latency communication. Alternatively or additionally, the CPUs 104A and 104B may be operatively coupled to GPUs 106A, 1046, 106C, and 106D via PCIe interconnects. These PCIe interconnects may utilize multi-lane configurations, such as PCIe Gen 4 or Gen 5×16 lanes, to provide high-bandwidth, scalable data transfer channels between the CPUs and GPUs. In this configuration, the PCIe interconnects may support dynamic link width adjustments, allowing the bandwidth to scale based on workload intensity, thereby optimizing resource allocation within the system.

GPUs 106A and 106B within HPC cluster 102A and GPUs 104C and 106D within HPC cluster 102B may be interconnected via NVLink® interconnects via NVLink® compatible ports, NVLink 0 and NVLink 1 respectively, allowing coordinated parallel processing across GPUs for computationally demanding workloads. HPC clusters 102A and 102B may be interconnected through high-bandwidth interconnect, such as an NVLink® or Unified Physical Layer (UPHY) interconnect, allowing for data transfer and synchronization between the server systems. The high-bandwidth interconnect may support parallel processing and may improve the overall computational throughput of the HPC cluster, making it suitable for applications like artificial intelligence (AI), machine learning (ML), and data-intensive simulations. Each CPU (e.g., 104A) within a HPC cluster (e.g., 102A) may be equipped with memory modules, such as a 512-bit memory module, to provide data access for both CPUs and GPUs. The memory modules may be directly connected to the respective CPUs, reducing latency and supporting high-speed operations.

As shown in FIG. 1, the HPC clusters 102A and 102B may be operatively coupled to NIC/DPUs 112, enabling efficient offloading of data processing and security tasks, further reducing the computational burden on the server CPUs and improving overall data flow within the rack. Each NIC/DPU 112 may integrate NIC and DPU functionalities to enhance the efficiency of data center operations. The NIC/DPU 112 may be configured to offload various network, storage, and security tasks from the HPC clusters (e.g., HPC cluster 102A, 102B), in particular, CPUs in the HPC clusters, allowing the CPUs to focus on compute-intensive workloads. The NIC/DPU 112 may facilitate high-speed data transmission, optimize data flow, and enable advanced network services with minimal impact on server performance. The NIC component within the NIC/DPU 112 may handle standard network functions, such as packet transmission and reception, supporting high-speed Ethernet or InfiniBand® protocols. By facilitating fast data transfers between the HPC clusters 102A and 102B and external networks 116, the NIC enables efficient communication across the datacenter environment. The NIC may also support offloading network protocol processing, reducing the overhead on HPC clusters 102A and 102B, in particular, CPUs in the HPC clusters 102A and 102B, and improving overall data throughput. The DPU component of the NIC/DPU 112 may extend these capabilities by offloading more advanced processing tasks, such as data encryption and decryption, packet inspection and filtering, virtualization support, and/or the like. In example embodiments, DPU may be NVIDIA BlueField®-2 DPUs, which provide a high-performance platform for data center acceleration. The BlueField-2 architecture may include up to 8 Arm cores, enabling the NIC/DPU 112 to execute network, storage, and security tasks independently of the HPC clusters, in particular, CPUs in the HPC clusters. By performing these tasks closer to the data source, the NIC/DPU 112 may reduce data movement across the network, lower latency, and enhance overall system efficiency.

The NIC/DPU 112 may also include a dedicated memory subsystem, such as dynamic random-access memory (DRAM), to support local processing and ensure high-speed data access. Additionally, the NIC/DPU 112 may be configured to manage NVMe over Fabrics (NVMe-oF) storage protocols, allowing for efficient remote storage access and fast data retrieval. The combined NIC and DPU functionalities within the NIC/DPU 112 may support various advanced networking features, including traffic shaping and load balancing, remote direct memory access (RDMA), virtual machine and container isolation, and/or the like.

Switches 114 may manage the data flow between the HPC clusters 102A, 102B and the external networks 116. The switches 114 may be responsible for routing and distributing data between servers within the datacenter and facilitating communication with external networks. Switches 114 may be configured to support various high-speed network protocols, such as Ethernet or InfiniBand® protocols, depending on the performance and bandwidth requirements of the datacenter. The switches 114 may include optical switches, which use light signals for data transmission, offering high bandwidth and low latency for long-distance communication. Alternatively, the switches 114 may include electrical switches, which rely on electronic signals and may be used for shorter distances or when lower latency is a priority. In some configurations, hybrid switches may be used, combining both optical and electrical components to balance performance and flexibility. The switches 114 may be advanced networking switches, such as Nvidia Quantum-2 switches, configured to provide high throughput capabilities. The switches 114 may operate at different layers of the network stack, including Layer 2 (data link layer) and Layer 3 (network layer), to perform switching and routing functions. Multiple switches 114 may be interconnected to provide redundancy and load balancing for reliable data transfer even if one switch fails. The switches 114 may support scalable configurations, allowing the network architecture to expand as additional HPC clusters 102A, 102B or external networks 116 are introduced.

In certain embodiments, the number and arrangement of switches 114 within the datacenter network architecture 100 may be based on the overall network topology deployed in the datacenter environment. The choice of network topology may influence the scalability, performance, fault tolerance, and bandwidth distribution of the network, thus affecting how many switches are required and how they are interconnected. Examples of network topology may include fat-tree topology, SlimFly topology, dragonfly topology, HyperX topology, torus topology, Clos (folded-Clos) topology, mesh topology and/or the like. For instance, in a fat-tree topology, the network is structured as a multi-tiered hierarchy with equal-cost paths between any two endpoints. The fat-tree topology may be built using three layers of switches: leaf switches at the bottom layer, directly connected to the HPC clusters 102A, 102B, spine switches in the middle layer, which interconnect the leaf switches, and core switches at the top, which interconnect multiple sets of spine switches. In a SlimFly topology, the switches 114 may be arranged to minimize the average path length between servers, reducing communication latency. The total number of switches 114 may be fewer than in fat-tree topology, but their arrangement may be more complex to optimize the number of direct and indirect connections between nodes. Dragonfly topology may organize switches into groups (or “pods”), with high-bandwidth connections within each group and lower-bandwidth connections between groups. The switches 114 may be arranged into several pods, with each pod containing a set of leaf switches connected to HPC clusters 102A, 102B and local spine switches. In addition, there may be fewer inter-pod connections than intra-pod connections. In hyperX topology, switches may be arranged in a multi-dimensional grid, with each switch connected to multiple neighboring switches in different dimensions. The total number of switches may scale with the number of dimensions and network size. In a torus topology, the switches 114 may be connected in a loop or ring structure. Torus topology may offer reduced wiring complexity and built-in redundancy, as each switch is connected to multiple adjacent switches. In larger datacenters, a higher-dimensional torus (e.g., 3D or 4D torus) may be implemented, where switches are arranged in a multi-layered grid. In a Clos topology, also known as a folded-Clos or CLOS architecture, the switches 114 may be arranged in multiple layers of switching stages, with each stage containing multiple switches. In this configuration, each server system 102 may connect to a set of leaf switches, which in turn connect to multiple spine switches. Additional spine and leaf switches may be added as the network grows, with the number of switches 114 increasing in proportion to the number of server systems and external networks connected.

The external networks 116 represent a range of connectivity options that facilitate communication between the datacenter and various external systems, such as other datacenters, cloud service providers, and/or the like. These external networks 116 may include local area networks (LANs), which connect devices within a limited geographical area, as well as WANs that span larger distances and connect multiple LANs. Additionally, external networks 116 may include cloud networks, which provide scalable resources and services hosted remotely, and private networks, which offer secure communication channels for sensitive data transfer. Other types of external networks may include virtual private networks (VPNs) that enable secure access over the internet and Content Delivery Networks (CDNs) that optimize the delivery of content to end-users. Each of these external networks may utilize various communication protocols, such as Ethernet, InfiniBand®, or MPLS (Multiprotocol Label Switching) protocols, to ensure reliable and efficient data transfer.

System 110 may manage and coordinate network resources within the datacenter network architecture 100, including link allocation and other resource distribution functionalities described herein. System 110 may be operatively coupled to various components, such as the HPC clusters 102A, 102B, NIC/DPU 112, and switches 114, facilitating efficient communication and resource management across the network infrastructure. In specific embodiments, the system 110 may interact with NIC/DPUs 112 to offload specific network management and data processing tasks from the HPC clusters 102A, 102B. The NIC/DPUs 112 may handle low-level data exchanges and route packets between HPC clusters 102A, 102B and network switches 106, enabling system 110 to focus on higher-level management tasks, such as link allocation across the data center environment. System 110 may communicate with NIC/DPUs 112 to monitor network conditions, adjust link allocations in response to changing demands, and ensure optimized data flows across the infrastructure. System 110 may also be in direct communication with network switches 106, which route data between HPC clusters 102A, 102B and external networks 116. Through this interaction, system 110 may determine the optimal allocation of network links for data transmission across switches 106, minimizing congestion and ensuring efficient resource utilization. In some embodiments, system 110 may control the allocation of both electrical and optical links, as well as the number of links activated or deactivated between switches 106 based on network traffic patterns. System 110 may adjust link allocations dynamically, managing inter-switch communication in response to varying data loads or operational demand.

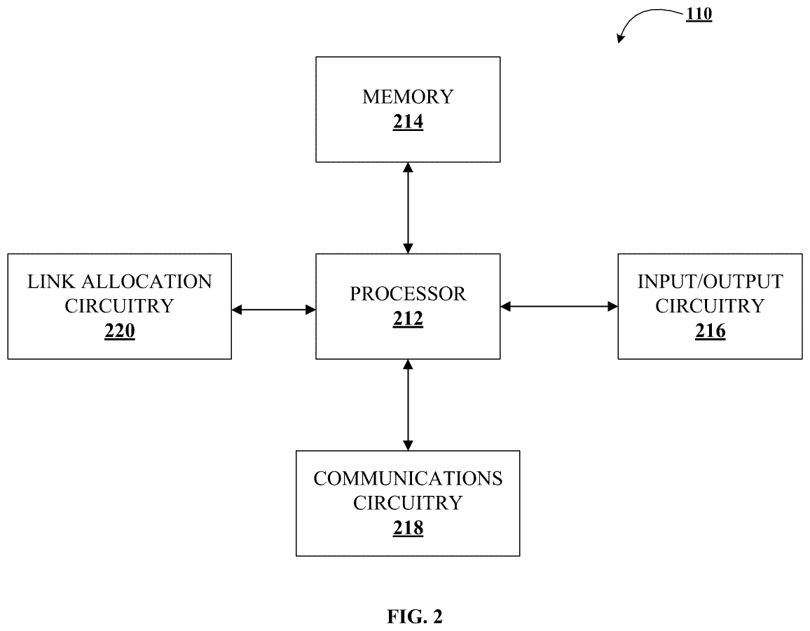

Within HPC clusters 102A, 102B, system 110 may oversee the distribution of computational tasks and manage interconnects between CPUs, GPUs, and other processing resources. For instance, system 110 may allocate available link bandwidth between CPUs and GPUs based on workload requirements, facilitating high-throughput, low-latency data exchanges as needed for AI, ML, and other computationally intensive applications. System 110 may use link allocation circuitry 220 (see FIG. 2) to implement link allocation policies across the datacenter environment, adjusting link usage according to the computational load and inter-device communication needs, as described herein.

Overall, system 110 may serve as the central control point for link allocation and network resource management within the datacenter network architecture 100, coordinating with NIC/DPUs 112, HPC clusters 102A, 102B, and switches 106 to ensure efficient resource utilization and optimized data flows across the network.

It should be noted that the description provided herein is merely one embodiment of the datacenter network architecture 100 and the associated components, including the switches 114 and the NIC/DPU 112. Various modifications, alterations, and adaptations may be made without departing from the scope of the disclosure. The specific configurations, components, and functionalities described are illustrative and may be replaced or modified in other embodiments depending on the particular requirements of the datacenter environment. For example, different network topologies, alternative processing units, or variations in server configurations may be used to achieve similar objectives. As such, the scope of the invention should not be limited by the described embodiment.

### Example System Circuitry

FIG. 2 illustrates a schematic block diagram of example circuitry, some or all of which may be included in the system 110. As shown in FIG. 2, the system 110 may include a processor 212, a memory 214, input/output circuitry 216, communications circuitry 218, and resource allocation circuitry. It should be understood that FIG. 2 is merely an illustrative embodiment and the system 110 may include more components, fewer components, or different components than those depicted. The arrangement of the components may also vary. Depending on specific implementation requirements, the system 110 may incorporate additional components or omit certain components. Variations in the configuration and composition of the system 110 are within the scope of the disclosure.

Although the term “circuitry” as used herein with respect to components 212-220 is described in some cases using functional language, it should be understood that the particular implementations necessarily include the use of particular hardware configured to perform the functions associated with the respective circuitry as described herein. It should also be understood that certain of these components 212-220 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the system 110 may be housed together, while other components are housed separately (e.g., a controller in communication with the system 110). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the system 110 may provide or supplement the functionality of particular circuitry. For example, the processor 212 may provide processing functionality, the memory 214 may provide storage functionality, the communications circuitry 218 may provide network interface functionality, and the like.

In some embodiments, the processor 212 (and/or co-processor or any other processing circuitry assisting or otherwise associated with the processor) may be in communication with the memory 214 via a bus for passing information among components of, for example, the system 110. The memory 214 may be non-transitory and may include, for example, one or more volatile and/or non-volatile memories, or some combination thereof. In other words, for example, the memory 214 may be an electronic storage device (e.g., a non-transitory computer readable storage medium). The memory 214 may be configured to store information, data, content, applications, instructions, or the like, for enabling an apparatus, e.g., the system 110, to carry out various functions in accordance with example embodiments of the present disclosure.

Although illustrated in FIG. 2 as a single memory, the memory 214 may comprise a plurality of memory components. The plurality of memory components may be embodied on a single computing device or distributed across a plurality of computing devices. In various embodiments, the memory 214 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 214 may be configured to store information, data, applications, instructions, or the like for enabling the system 110 to carry out various functions in accordance with example embodiments discussed herein. For example, in at least some embodiments, the memory 214 may be configured to buffer data for processing by the processor 212. Additionally, or alternatively, in at least some embodiments, the memory 214 may be configured to store program instructions for execution by the processor 212. The memory 214 may store information in the form of static and/or dynamic information. This stored information may be stored and/or used by the system 110 during the course of performing its functionalities.

The processor 212 may be embodied in a number of different ways and may, for example, include one or more processing devices configured to perform independently. Additionally, or alternatively, the processor 212 may include one or more processors configured in tandem via a bus to enable independent execution of instructions, pipelining, and/or multithreading. The processor 212 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 212 may include a plurality of processors. The plurality of processors may be embodied on a single computing device or may be distributed across a plurality of such devices collectively configured to function as the system 110. The plurality of processors may be in operative communication with each other and may be collectively configured to perform one or more functionalities of the system 110 as described herein.

In an example embodiment, the processor 212 may be configured to execute instructions stored in the memory 214 or otherwise accessible to the processor 212. Alternatively, or additionally, the processor 212 may be configured to execute hard-coded functionality. As such, whether configured by hardware or software methods, or by a combination thereof, the processor 212 may represent an entity (e.g., physically embodied in circuitry) capable of performing operations according to an embodiment of the present disclosure while configured accordingly. Alternatively, as another example, when the processor 212 is embodied as an executor of software instructions, the instructions may specifically configure the processor 212 to perform one or more algorithms and/or operations described herein when the instructions are executed. For example, these instructions, when executed by the processor 212, may cause the system 110 to perform one or more of the functionalities thereof as described herein.

In some embodiments, the system 110 further includes input/output circuitry 216 that may, in turn, be in communication with the processor 212 to provide an audible, visual, mechanical, or other output and/or, in some embodiments, to receive an indication of an input from a user or another source. In that sense, the input/output circuitry 216 may include means for performing analog-to-digital and/or digital-to-analog data conversions. The input/output circuitry 216 may include support, for example, for a display, touchscreen, keyboard, mouse, image capturing device (e.g., a camera), microphone, and/or other input/output mechanisms. The input/output circuitry 216 may include a user interface and may include a web user interface, a mobile application, a kiosk, or the like. The input/output circuitry 216 may interface with one or more units, devices, sensors, actuators, communication modules, storage devices, external processing units, peripheral devices, and/or the like. These outputs may then be transmitted to one or more destinations, such as display units, storage systems, control systems, processors (e.g., processor 212), network interfaces, peripheral devices, external systems, and/or the like, for further action.

The processor 212 and/or user interface circuitry comprising the processor 212 may be configured to control one or more functions of a display or one or more user interface elements through computer-program instructions (e.g., software and/or firmware) stored on a memory accessible to the processor 212 (e.g., the memory 214, and/or the like). In some embodiments, aspects of input/output circuitry 216 may be reduced as compared to embodiments where the system 110 may be implemented as an end-user machine or other type of device designed for complex user interactions. In some embodiments (like other components discussed herein), the input/output circuitry 216 may be eliminated from the system 110. The input/output circuitry 216 may be in communication with memory 214, communications circuitry 218, and/or any other component(s), such as via a bus. Although more than one input/output circuitry and/or other component can be included in the system 110, only one is shown in FIG. 2 to avoid overcomplicating the disclosure (e.g., as with the other components discussed herein).

The communications circuitry 218, in some embodiments, includes any means, such as a device or circuitry embodied in either hardware, software, firmware or a combination of hardware, software, and/or firmware, that is configured to receive and/or transmit data from/to a network and/or any other device, or circuitry associated therewith. In this regard, the communications circuitry 218 may include, for example, a network interface for enabling communications with a wired or wireless communication network. For example, in some embodiments, communications circuitry 218 may be configured to receive and/or transmit any data that may be stored by the memory 214 using any protocol that may be used for communications between computing devices. For example, the communications circuitry 218 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 218 may include circuitry for interacting with the antenna(s) to cause transmission of signals via the antenna (e) or to handle receipt of signals received via the antenna (e). These signals may be transmitted by the system 110 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 218 may additionally or alternatively be in communication with the memory 214, the input/output circuitry 216, and/or any other component of the system 110, such as via a bus.

Referring again to FIG. 2, the link allocation circuitry 220 may be configured to manage and optimize the allocation of links between switches 114 (e.g., the plurality of electrical switches and optical switches), facilitating efficient data transmission and communication across different network layers, as depicted in the datacenter network architecture 100. The link allocation circuitry 220 may receive link allocation requests that specify the number of links to be allocated between each electrical switch-pair via corresponding optical switches. Upon receiving the link allocation request, the link allocation circuitry 220 may determine the maximum number of links available for allocation between each pair of electrical switches based on the availability of ports, existing link utilization, and the overall network conditions. Once the maximum number of links is determined for each electrical switch-pair, the link allocation circuitry 220 may allocate the required links according to a predefined allocation policy (e.g., round robin policy). If the link allocation request cannot be fully satisfied using the round-robin policy, the link allocation circuitry 220 may be configured to automatically attempt additional allocation strategies, such as sequential, least-loaded, most-loaded, or preferred batch allocation policies.

In some embodiments, the system 110 may include hardware, software, firmware, and/or a combination of such components, configured to support various aspects of combinatorial optimization as described herein. It should be appreciated that in some embodiments, the resource allocation circuitry 220 may perform one or more of such example actions in combination with another circuitry of the system 110, such as the memory 214, processor 212, input/output circuitry 216, and communications circuitry 218. For example, in some embodiments, the resource allocation circuitry 220 may utilize processing circuitry, such as the processor 212 and/or the like, to form a self-contained subsystem to perform one or more of its corresponding operations. In a further example, and in some embodiments, some or all of the functionality of the resource allocation circuitry 220 may be performed by the processor 212. In this regard, some or all of the example processes and algorithms discussed herein can be performed by at least one processor 212, and the resource allocation circuitry 220. It should also be appreciated that, in some embodiments, the resource allocation circuitry 220 may include a separate processor, specially configured FPGA, or ASIC to perform its corresponding functions.

Additionally, or alternatively, in some embodiments, the resource allocation circuitry 220 may use the memory 214 to store collected information. For example, in some implementations, the resource allocation circuitry 220 may include hardware, software, firmware, and/or a combination thereof, that interacts with the memory 214 to send, retrieve, update, and/or store data.

Accordingly, non-transitory computer readable storage media, which may, for example, be the memory 214, can be configured to store firmware, one or more application programs, and/or other software, which include instructions and/or other computer-readable program code portions that can be executed to direct operation of the system 110 to implement various operations, including the examples described herein. As such, a series of computer-readable program code portions may be embodied in one or more computer-program products and can be used, with a device, system 110, database, and/or other programmable apparatus, to produce the machine-implemented processes discussed herein. It is also noted that all or some of the information discussed herein can be based on data that is received, generated and/or maintained by one or more components of the system 110. In some embodiments, one or more external systems (such as a remote cloud computing and/or data storage system) may also be leveraged to provide at least some of the functionality discussed herein.

### Example Method for Link Allocation

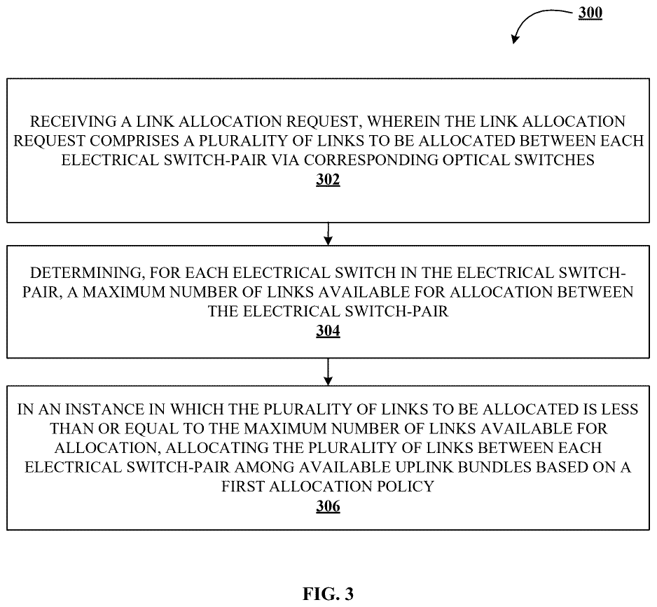

FIG. 3 illustrates a method 300 for link allocation, in accordance with an embodiment of the disclosure. The method 300 may be executed by the system 110 to optimize the allocation of uplink connections between electrical switches (or servers) and optical switches within a network environment. While the description of various embodiments of the disclosure primarily references the optimization of uplink connections between electrical switches and optical switches within a network environment, it is to be understood that the disclosure is not limited to such configurations. For instance, embodiments of the disclosure are intended to include, without limitation, the direct connection of servers to optical switches, which may be implemented in certain embodiments or future applications.

As shown in block 302, a link allocation request is received. As described herein, a link allocation request may refer to a set of instructions or parameters that specify the number of links to be allocated between two or more electrical switches via corresponding optical switches. Specifically, the link allocation request may include a plurality of links to be allocated between each electrical switch-pair via corresponding optical switches. As described herein, the plurality of links may facilitate communication between the electrical switch-pair. Optical switches may be used as intermediaries, enabling high-speed data transmission between the electrical switches in the electrical switch-pair. Alternatively or additionally, optical switches may be used as intermediaries, between servers. In example embodiments, the link allocation request may also include information such the type of communication pattern, communication requirements, priority levels of the requested links, and/or the like.

As shown in block 304, for each electrical switch in the electrical switch-pair, a maximum number of links available for allocation between the electrical switch-pair is determined. Each electrical switch in the electrical switch-pair may have a finite number of ports or uplinks, which may limit the number of connections that can be established between switches at any given time. The maximum number of links that can be established between each electrical-switch pair may be based on an uplink bundle associated with each electrical switch in the electrical switch-pair. An uplink bundle may refer to a collection of links connecting an electrical switch to the same optical switch. Each uplink bundle may represent a group of connections that enables data transmission between the electrical switch and an optical switch, facilitating communication across the network. In network environments where both electrical and optical switches are used, uplink bundles may define the capacity and performance of the system. The size of the uplink bundle may determine how much traffic can be routed from an electrical switch through a particular optical switch.

The maximum number of links that can be established between each electrical-switch pair may be determined by assessing the available uplink bundles associated with each electrical switch in the pair. For instance, the first electrical switch may be associated with a first uplink bundle that includes a first number of available links, and the second electrical switch may be associated with a second uplink bundle that includes a second number of available links. Each uplink bundle represents the set of connections that link an electrical switch to a corresponding optical switch, and the number of available links in these bundles reflects the capacity for additional connections. Upon determining the first number of available links and the second number of available links, the maximum number of links for allocation may be determined as a minimum of the first and second numbers of available links. Even if one electrical switch in the electrical switch-pair has more available links, the actual number of links allocated between the switch-pair is constrained by the switch with fewer available links. For example, if the first electrical switch has 12 available links in its uplink bundle, but the second electrical switch only has 8 available links in its uplink bundle, the maximum number of links that can be allocated between this switch-pair will be 8. This ensures that the system does not attempt to allocate more links than can physically be supported by either switch.

As shown in block 306, in an instance in which the plurality of links to be allocated is less than or equal to the maximum number of links available for allocation, the plurality of links between each electrical switch-pair among available uplink bundles is determined based on a first allocation policy. In an example embodiment, the first allocation policy may be a round-robin allocation. In this method, links are distributed evenly across the available uplink bundles to prevent overloading any single bundle. However, other policies, such as least-loaded, most-loaded, or preferred batch, as described in detail below, can also be used as the first allocation policy, depending on the network's requirements and the specific conditions of the link allocation request.

In instances in which the plurality of links to be allocated is more than the maximum links available for allocation, the link allocation request may be queued until more network resources become available. Examples of additional resources may include newly freed ports on electrical or optical switches, the deallocation of existing links due to task completion, or new hardware becoming operational in the network. The availability of resources may be continuously monitored, and when the condition is met—i.e., the number of requested links is equal to or less than the available links—the link allocation process may proceed. However, if the required resources do not become available within a predefined period, the link allocation request may be denied. Alternatively or additionally, in instances in which the plurality of links to be allocated is more than the maximum links available for allocation, the link allocation request may still be executed, where various allocation policies may be used to allocate the maximum available links, albeit with reduced bandwidth.

If the plurality of links to be allocated is less than or equal to the maximum number of links available for allocation, the plurality of links between each electrical switch-pair may be allocated using a first allocation policy. Conventional allocation policies often use sequential allocation, where links are assigned in a step-by-step manner. In a sequential allocation policy, links between electrical switch-pairs may be distributed in a step-by-step process. Uplink bundles may be allocated sequentially, starting with the first bundle, and moving to the next only after the first is fully utilized. Uplink bundles may be sorted in ascending order based on their identification numbers, such that the first bundle is allocated first, followed by subsequent bundles. All available links from the first bundle may be allocated until either the required number of links is met, or the bundle is fully used. Once the first bundle is exhausted, the allocation may proceed to the next bundle in the sorted order. This process may continue until the necessary number of links has been allocated.

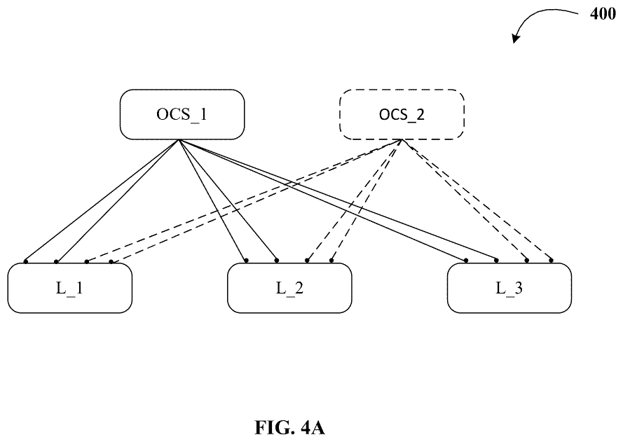

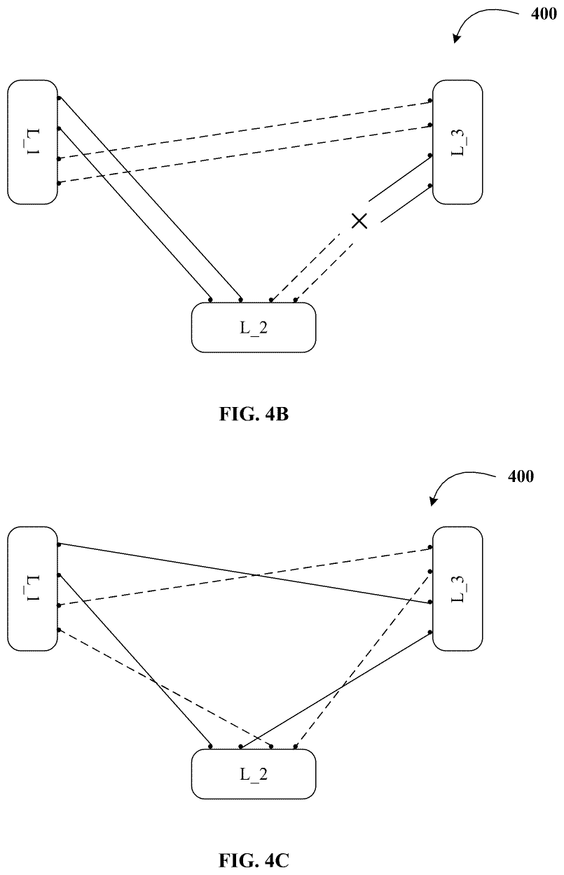

However, as described in FIGS. 4A-4C, sequential allocation, while straightforward, may lead to inefficiencies in certain network configurations. In a sequential allocation policy, links between electrical switch-pairs may be distributed by fully utilizing the available links in one uplink bundle before moving on to the next. As illustrated in FIG. 4B, this method may work effectively for initial link allocations. However, by the time the process reaches subsequent leaf-switch pairs, the available ports on the core switches may be exhausted due to earlier allocations, resulting in a situation where no available links remain to satisfy the allocation request for the final pair, as shown in FIG. 4B. As such, sequential allocation may lead to an imbalance in network traffic. Certain uplink bundles may become overutilized, handling a disproportionate amount of traffic, while other uplink bundles remain underutilized. Such imbalances may increase the blocking ratio, particularly for tasks that span multiple leaf switches. Overloaded bundles may create congestion, leading to inefficiencies in network performance, while unused resources in other bundles remain idle. To address these issues, alternative allocation policies, such as round-robin allocation, least-loaded allocation, most-loaded allocation, or preferred batch allocation, may be employed. While sequential allocation may still be used in certain scenarios, it is not always the preferred method due to its tendency to create imbalanced network load.

In a round-robin allocation policy, links between electrical switch-pairs may be distributed evenly across the available uplink bundles. Unlike sequential allocation, where links are allocated in one bundle before moving to the next, the round-robin policy allocates links in a cyclical manner, spreading the load more evenly across all available resources, as described in more detail in FIGS. 4C. Similar to the sequential allocation policy, the uplink bundles may be sorted in ascending order based on their identification numbers. Once sorted, the allocation process may begin by assigning one link from each bundle in a rotating fashion. For example, one link may be allocated from the first uplink bundle, then one link from the second bundle, and so on, cycling through the sorted list of bundles. Once all bundles have contributed one link, the process repeats in the same order until the total number of requested links is satisfied. By allocating links in such a manner, the round-robin policy helps to mitigate the blocking issues seen in sequential allocation. No single uplink bundle or core switch may be overused, which reduces the likelihood of bottlenecks and improves overall network efficiency.

In a least-loaded allocation policy, links between electrical switch-pairs may be allocated with a preference for the uplink bundles that are currently handling the least traffic. The least-loaded allocation policy ensures that the least-utilized bundles are prioritized, allowing for more balanced traffic distribution across the network. By focusing on underutilized bundles, the least-loaded policy can reduce the chances of congestion and ensure more even use of available network resources. The allocation process may begin by sorting the uplink bundles according to the number of links they have already allocated. Bundles with the fewest allocated links may be placed at the top of the list, with the more heavily loaded bundles sorted lower in ascending order. Once the bundles are sorted, link allocation may proceed starting from the least-loaded bundle at the top of the list. The allocation process itself may follow either a sequential or round-robin approach. As described herein, in the sequential method, all available links may be allocated from the least-loaded bundle before moving on to the next. Alternatively, in the round-robin method, one link may be allocated from each bundle, starting from the least-loaded, and continuing in cycles until the requested number of links is allocated. By prioritizing the least-loaded bundles, this policy ensures that network resources are distributed more evenly, preventing overuse of heavily utilized bundles.

In a most-loaded allocation policy, links between electrical switch-pairs may be allocated with a preference for the uplink bundles that are currently handling the highest amount of traffic. The most-loaded application policy may prioritize the use of bundles that are already heavily utilized, which can help consolidate traffic on fewer paths and potentially free up less-utilized bundles for future allocations. The process begins by sorting the uplink bundles based on the number of links they have already allocated. Bundles with the most allocated links are placed at the top of the list, and bundles with fewer links are sorted lower in descending order. Once the bundles are sorted, the allocation may proceed starting from the most-loaded bundle at the top of the list. Similar to the least-loaded allocation policy, the allocation process can follow either a sequential or round-robin approach. In the sequential method, all available links from the most-loaded bundle may be allocated before moving to the next bundle in the list. In the round-robin approach, one link from each of the most-loaded bundles may be allocated in cycles until the requested number of links is fully allocated. By prioritizing the most-loaded bundles, this policy maximizes the usage of the network's most active pathways, such that underused bundles remain available for other purposes.

The preferred-batch allocation policy may be particularly useful in situations involving large-scale, all-to-all communication jobs where traffic patterns follow powers of 2. In a preferred-batch allocation policy, links between electrical switch-pairs may be allocated based on a batch size. The batch size may indicate the maximum number of inter-switch connections required by any electrical switch-pair. The batch size for all electrical switch-pairs may be calculated using the formula,

$$batch size = ⌈ \frac{{h}_{1} * {h}_{2}}{N} ⌉ .$$

Here, h₁ may be the number of hosts under the first electrical switch in the electrical switch-pair, h₂ may be the number of hosts under the second electrical switch pair, and N may be the total number of compute nodes distributed across all the electrical switches. The maximum number of inter-switch connections required by any electrical switch-pair may be used to determine the number of links that need to be allocated at each step of the process. As such, the batch size may be used to determine that an appropriate number of links are reserved for each electrical switch-pair, preventing overutilization or underutilization of network resources. For each electrical switch-pair, the preferred batch may be determined using the equation,

$$preferredBatch = ( srcSwitchID + dstSwitchID ) mod nrSwitces .$$

Here, srcSwitchID may refer to the source electrical switch ID, dstSwitchID may refer to the destination electrical switch ID, and nrSwitches may refer to the total number of switches in the network. The result of this calculation gives the preferred batch for the electrical switch-pair, which determines where in the network the link allocation will start. The preferred port from which the allocation may begin may be calculated using the equation:

$$preferredPort = preferredBatch * batchSize .$$

The resulting value may provide the initial port from which the allocation of links may begin for the respective electrical switch-pair. The allocation may then proceed by assigning the calculated number of links (equal to the batch size) starting from the calculated port.

For instance, in a network with 128 compute nodes distributed across 4 electrical switches, with 32 hosts per electrical switch, the batch size may be

$$⌈ \frac{32 * 32}{128} ⌉ = 8 ;$$

the preferred batch for srcSwitch0 and dstSwitch1 may be (0+1)mod 4=1; which means that the allocation will start at preferred port (1*8)=8, and use ports 8-15 for allocation. The same calculation may be applied for other switch pairs, such as srcSwitch0 and dstSwitch2, srcSwitch0 and dstSwitch3, and so on to determine their respective preferred batches and preferred ports for allocation.

If the allocation is successful using the first allocation policy—that is, if the requested number of links is allocated between the electrical switch-pair—the allocation of links for additional electrical switch-pairs in the network may proceed. The allocation process can be performed either sequentially or across all switch-pairs simultaneously or concurrently, depending on the system configuration and network conditions. On the other hand, if the link allocation request is unsuccessful using the first allocation policy, the sequential attempts to use additional allocation policies (e.g., round-robin among the uplink bundles, sequential allocation, least-loaded allocation, most-loaded allocation, or preferred batch allocation) may be initiated until the requested number of links is successfully allocated between each electrical switch-pair. round-robin among the uplink bundles, sequential allocation, least-loaded allocation, most-loaded allocation, or preferred batch allocation. If the link allocation request remains unsuccessful using the additional allocation policies, a user (e.g., a user associated with the system 110) may be alerted to the failure of the allocation process, prompting manual intervention or further system adjustments to address the unmet link requirements.

The order in which these allocation policies are selected may depend on the specific network configuration, traffic patterns, or operational requirements of the system. The selection of allocation policies is not limited to the examples provided above, and other allocation policies may also be employed within the scope of the present disclosure. The use of alternative policies, variations, or modifications that achieve the intended link allocation results are considered to be within the spirit and scope of the invention. These policies may be adapted or tailored to suit different network environments or performance objectives, ensuring flexible and efficient link allocation in various system configurations.

It should be understood that while the functionalities describe above refer to “electrical switches” and “optical switches” in specific contexts, these terms are intended to be illustrative and not limiting. The switches utilized within the network topology, including those involved in the link allocation process, may be electrical switches, optical switches, or any combination thereof. The system described herein may be configured to operate with any type of switch, depending on the specific requirements of the network architecture. Therefore, the use of electrical and optical switches in particular embodiments is meant to cover all possible configurations of switches, including hybrid and alternative implementations, without limiting the scope of the disclosure.

### Example Illustration of Link Allocation within Network Segment

FIGS. 4A-4C illustrate link allocation within an example network segment 400 of the datacenter network architecture 100, in accordance with an embodiment of the disclosure. As shown in FIG. 4A, the example network segment 400 includes two optical switches OCS_1 and OCS_2, which may be core layer switches (CLSs) in the core layer. The example network segment 400 also includes three leaf switches L_1, L_2, and L_3, which may be aggregation layer switches (ALSs) in the aggregation layer or edge layer switches (ELSs) in the edge layer, depending on their assigned role within the network hierarchy. Each leaf switch is connected to the optical switches via four uplinks, facilitating communication between the different layers.

In an example embodiment, the link allocation request for the example network segment 400 may require establishing two links per leaf-switch pair. Conventionally, a sequential routing method has been employed for link allocation. The sequential routing method may begin by allocating links sequentially. The allocation process may begin with the first leaf-switch pair, L1 and L2. The sequential routing method allocates the first two available links between L1 and L2. As shown by the solid lines in FIG. 3B, two links may be established between L1 and L2. The two links may be routed through OCS 1 and OCS 2, utilizing the available ports on both L1 and L2. The allocation successfully completes the link requirements for the L1-L2 switch pair. Next, the sequential routing moves to the next pair, L1 and L3. The sequential routing method assigns the next available links from L1 to L3, as indicated by the dotted lines in FIG. 4B. Two links are established between L1 and L3, routed through OCS 1 and OCS 2 using available ports. At this point, L1 is fully allocated with connections to both L2 and L3, and the link requirements for the L1-L3 switch pair are also met. The allocation process then moves to the final leaf-switch pair, L2 and L3. However, during this step, the sequential routing encounters an issue. Since the ports have already been used to connect L1 to both L2 and L3, there are no remaining ports on the appropriate optical core switches (OCS 1 and OCS 2) to establish the required two links between L2 and L3. This situation is illustrated in FIG. 4B, where no further connections (solid or dotted lines) can be drawn between L2 and L3, indicating that no links are available for this pair.

Unlike the sequential routing method, the round-robin policy aims to allocate links evenly across the available core switches to prevent port exhaustion and optimize network resource utilization. As illustrated in FIG. 4C, the allocation process begins with the first leaf-switch pair, L1 and L2. The round-robin policy may assign the first available link between L1 and L2 using a solid line connection via one of the core switches (e.g., OCS_1). For the second link between L1 and L2, the round-robin policy assigns a connection using the other core switch (e.g., OCS_2). The allocation method then moves to the next pair, L1 and L3. Similarly, the round-robin policy may assign the first available link between L1 and L3 using a solid line connection via one of the core switches (e.g., OCS_1), and the second available link between L1 and L3 using a dotted line connection via the other core switch (e.g., OCS_2). The allocation process then moves to the final leaf-switch pair, L2 and L3. Continuing with the round-robin policy, the first link between L2 and L3 is assigned using one core switch (e.g., OCS_1), as shown using the solid line, while the second link between L2 and L3 is assigned using the other core switch (e.g., OCS_2), as shown using the dotted line. As such, using the round-robin allocation policy allows for an even distribution of link usage across the available core switches, avoiding the challenges of the sequential routing method, such as port exhaustion on a particular core switch.

It should be understood that the example network segment 400 depicted in FIGS. 4A-4C is provided solely for illustrative purposes to facilitate an understanding of the concepts underlying the present disclosure. This representation is not intended to limit the scope of the invention to any particular network configuration or topology. Various modifications, adaptations, and alternative configurations of network segments may be utilized to implement the principles of the invention, all of which are considered to fall within the scope and spirit of the present disclosure.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for link allocation, the method comprising:
receiving a link allocation request, wherein the link allocation request comprises a plurality of links to be allocated between each electrical switch-pair via corresponding optical switches;
determining, for each electrical switch in the electrical switch-pair, a maximum number of links available for allocation between the electrical switch-pair; and
in an instance in which the plurality of links to be allocated is less than or equal to the maximum number of links available for allocation, allocating the plurality of links between each electrical switch-pair among available uplink bundles based on a first allocation policy, wherein the first allocation policy comprises a round-robin allocation policy.

2. The method of claim 1, wherein the first allocation policy comprises at least one of a sequential, least-loaded, most-loaded, or preferred batch allocation policy.

3. The method of claim 1, wherein determining the maximum number of links that can be established between each electrical switch-pair is based on an uplink bundle associated with each electrical switch in the electrical switch-pair.

4. The method of claim 3, wherein determining the maximum number of links for allocation further comprises:
determining a first number of available links associated with a first electrical switch in the electrical switch-pair;
determining a second number of available links associated with a second electrical switch in the electrical switch-pair; and
determining a minimum of the first number of available links and the second number of available links,
wherein the first number of available links and the second number of available links are associated with the uplink bundle.

5. The method of claim 1, further comprising:
determining that the link allocation request is successful in an instance in which the plurality of links is allocated between each electrical switch-pair.

6. The method of claim 5, further comprising:
determining that the link allocation request between a first electrical switch-pair is successful; and
initiating the allocation in additional electrical switch-pairs.

7. The method of claim 5, further comprising:
executing a task in response to determining that the link allocation request is successful.

8. The method of claim 1, further comprising:
allocating the plurality of links between each electrical switch-pair concurrently.

9. The method of claim 1, further comprising:
in an instance in which the link allocation request is unsuccessful using the first allocation policy, sequentially attempting additional allocation policies until the plurality of links is successfully allocated between each electrical switch-pair.

10. The method of claim 9, wherein the additional allocation policies comprise at least one of a round-robin among the uplink bundles, a sequential, least-loaded, most-loaded, or preferred batch allocation policy.

11. The method of claim 9, further comprising:
in an instance in which the additional allocation policies were unsuccessful, transmitting an alert to a user indicating that additional allocation policies were unsuccessful.

12. The method of claim 1, wherein the link allocation request is associated with a communication pattern.

13. A system for link allocation, the system comprising:
a plurality of electrical switches;
a plurality of optical switches operatively coupled to the plurality of electrical switches;
link allocation circuitry operatively coupled to the plurality of electrical switches and the plurality of optical switches, and configured to:
receive a link allocation request, wherein the link allocation request comprises a plurality of links to be allocated between each electrical switch-pair via corresponding optical switches;
determine, for each electrical switch in the electrical switch-pair, a maximum number of links available for allocation between the electrical switch-pair; and
in an instance in which the plurality of links to be allocated is less than or equal to the maximum number of links available for allocation, allocate the plurality of links between each electrical switch-pair among available uplink bundles based on a first allocation policy, wherein the first allocation policy comprises a round-robin allocation policy.

14. The system of claim 13, wherein the link allocation circuitry is further configured to:
determine the maximum number of links that can be established between each electrical switch-pair is based on an uplink bundle associated with each electrical switch in the electrical switch-pair.

15. The system of claim 14, wherein, in determining the maximum number of links for allocation, the link allocation circuitry is further configured to:
determine a first number of available links associated with a first electrical switch in the electrical switch-pair;
determine a second number of available links associated with a second electrical switch in the electrical switch-pair; and
determine a minimum of the first number of available links and the second number of available links,
wherein the first number of available links and the second number of available links are associated with the uplink bundle.

16. The system of claim 13, wherein the link allocation circuitry is further configured to:
determine that the link allocation request is successful in an instance in which the plurality of links is allocated between each electrical switch-pair.

17. The system of claim 16, wherein the link allocation circuitry is further configured to:
determine that the link allocation request between a first electrical switch-pair is successful; and
initiate the allocation in additional electrical switch-pairs.

18. The system of claim 13, wherein the link allocation circuitry is further configured to:
in an instance in which the link allocation request is unsuccessful using the first allocation policy, sequentially attempt additional allocation policies until the plurality of links is successfully allocated between each electrical switch-pair.

19. A computer program product for link allocation, the computer program product comprising a non-transitory computer-readable medium comprising code that, when executed by a processor, causes the processor to:
receive a link allocation request, wherein the link allocation request comprises a plurality of links to be allocated between each electrical switch-pair via corresponding optical switches;
determine, for each electrical switch in the electrical switch-pair, a maximum number of links available for allocation between the electrical switch-pair; and
in an instance in which the plurality of links to be allocated is less than the maximum number of links available for allocation, allocate the plurality of links between each electrical switch-pair among available uplink bundles based on a first allocation policy, wherein the first allocation policy comprises a round-robin allocation policy.

20. The computer program product of claim 19, wherein the code, when executed by the processor, further causes the processor to:
determine the maximum number of links that can be established between each electrical switch-pair is based on an uplink bundle associated with each electrical switch in the electrical switch-pair.
